(19) United States
(12) Patent Application Publication
(10) Pub. No.: US 2026/0250512 A1
(43) Pub. Date: Aug. 27, 2026

(54) ASPHALT COMPOSITIONS WITH IMPROVED LOW TEMPERATURE ADHESION PERFORMANCE

(71) Applicant: Owens Corning Intellectual Capital, LLC, Toledo, OH (US)

(72) Inventors: Ozma Norma Redd Pierce Lane, Columbus, OH (US); Alison R. Schultz, Columbus, OH (US); William Edwin Smith, Pataskala, OH (US); Jay Beck, Mount Vernon, OH (US); Brian Frederick Shaeffer, Pataskala, OH (US); Sara Akbarian-Tefaghi, New Albany, OH (US)

(21) Appl. No.: 19/534,987

(22) Filed: Feb. 10, 2026

Related U.S. Application Data
(60) Provisional application No. 63/761,386, filed on Feb. 21, 2025.

(51) Int. Cl. C08L 95/00

(52) U.S. Cl. CPC C08L 95/00; C08L 2555/64

(57) ABSTRACT

Asphalt compositions comprising a phenolic lipid-based compatibilizer are provided. The phenolic lipid-based compatibilizer provides improved low temperature adhesion performance (i.e., at 40° F. or below) to the asphalt composition, which is particularly useful in roofing applications, such as asphalt-based shingles and underlayments.

### CROSS-REFERENCE TO RELATED APPLICATIONS

This application claims priority to and all benefit of U.S. Provisional Application No. 63/761,386, filed Feb. 21, 2025, the entire disclosure of which is fully incorporated herein by reference.

### FIELD

The present disclosure relates to asphalt compositions comprising a phenolic lipid-based compatibilizer. Specifically, the phenolic lipid-based compatibilizer provides improved low temperature adhesion performance (i.e., at 40° F. or below) to the asphalt composition. The improved low temperature adhesion performance makes the resultant asphaltic products especially useful in roofing applications, such as asphalt-based shingles and underlayments.

### BACKGROUND

In general, asphalt-based roofing materials, such as roofing shingles and underlayments, are installed on the roofs of buildings to provide protection from the elements and to give the roof an aesthetically pleasing look.

A roofing underlayment is a water-resistant sheet installed on a roof deck prior to installing shingles or other coverings on the roof. The roofing underlayment comprises a multi-layer structure including, inter alia, one or more layers comprising an asphalt composition. It is desirable that the underlayment is dimensionally stable, resistant to tearing, easy to unroll and install, and provides hot and cold flexibility. A variety of roofing underlayment products are commonly used. The two major classes are mechanically attached and self-adhered underlayments, the latter of which is commonly referred to as “peel and stick.”

Roofing shingles are then typically applied on top of the underlayment in successive rows. In general, asphalt-based roofing shingles are made by mixing asphalt with supplemental materials to make an asphalt coating. A substrate, such as a glass fiber mat or an organic felt, is then coated on each side and saturated with the asphalt coating, forming an asphalt-coated substrate that may subsequently be coated with granules to form the shingle. An adhesive or sealant may be placed on the shingles to bond together successive layers of shingles during installation. The use of adhesives, including asphaltic compounds, to provide a bond between roofing shingles when they are attached to a roof is well-known.

That said, it has been found that cold weather (i.e., temperatures of 40° F. or less) presents a consistent hurdle to the adhesion performance of asphalt compositions, both in shingles (i.e., the asphalt sealant of shingles) and underlayments (i.e., the adhesive layer(s) of underlayments). This is because in order to seal properly, most conventional sealants or adhesives require relatively high roof temperatures (135° F. or higher) to fully activate the adhesive. Thus, under conditions where relatively low temperatures do not permit proper sealing of the adhesive, the roofing products may not be properly sealed.

As such, a need exists for asphalt compositions that provide improved low temperature adhesion (i.e., at 40° F. or less), without sacrificing standard adhesion performance.

### SUMMARY

Disclosed herein are asphalt-based roofing materials comprising a phenolic lipid-based compatibilizer.

In accordance with a first aspect of the present disclosure, an asphalt composition is disclosed. The asphalt composition comprises a modified asphalt material, the modified asphalt material comprising from 10 to 99 wt. % of a base asphalt, based upon the total weight of the modified asphalt material; and from 1 to 20 wt. % of a phenolic lipid-based compatibilizer, based upon the total weight of the modified asphalt material, wherein the asphalt composition exhibits an improved adhesion at temperatures of 40° F. or lower as compared to an otherwise identical asphalt composition devoid of the phenolic lipid-based compatibilizer.

In a second aspect of the disclosure, which may be combined with any other aspect listed herein unless specified otherwise, the asphalt composition comprises: the modified asphalt material; and a filler material.

In a third aspect of the disclosure, which may be combined with any other aspect listed herein unless specified otherwise, the modified asphalt material comprises from 1.5 to 10 wt. % of the phenolic lipid-based compatibilizer, based upon the total weight of the modified asphalt material.

In a fourth aspect of the disclosure, which may be combined with any other aspect listed herein unless specified otherwise, the asphalt composition has a bond strength at 40° F. of 5 to 50 lbs. of force, as measured in accordance with modified ASTM D6381 (defined below).

In a fifth aspect of the disclosure, which may be combined with any other aspect listed herein unless specified otherwise, the asphalt composition exhibits an improved penetration value at 77° F. as compared to an otherwise identical asphalt composition devoid of the phenolic lipid-based compatibilizer.

In a sixth aspect of the disclosure, which may be combined with any other aspect listed herein unless specified otherwise, the asphalt composition has a penetration value at 77° F. of 70 dmm or greater, as measured in accordance with ASTM D5.

In a seventh aspect of the disclosure, which may be combined with any other aspect listed herein unless specified otherwise, the asphalt composition exhibits an improved viscosity at temperatures of 300° F. or higher, as compared to an otherwise identical asphalt composition devoid of the phenolic lipid-based compatibilizer.

In an eighth aspect of the disclosure, which may be combined with any other aspect listed herein unless specified otherwise, the base asphalt comprises paving grade asphalt, oxidized asphalt, non-oxidized asphalt, or mixtures thereof.

In a nineth aspect of the disclosure, which may be combined with any other aspect listed herein unless specified otherwise, the modified asphalt material is a polymer-modified asphalt material comprising an amount up to 20 wt. % of a polymer additive, based upon the total weight of the modified asphalt material.

In a tenth aspect of the disclosure, which may be combined with any other aspect listed herein unless specified otherwise, the polymer additive comprises one or more of reclaimed rubber, natural rubber, ground tire rubber, depolymerized ground tire rubber, styrene-butadiene block copolymer (SBS), chloroprene rubber (CR), amorphous polyolefin, latex, butadiene rubber (BR), acrylonitrile-butadiene rubber (NBR), isoprene rubber (IR), styrene-isoprene, styrene-polyisoprene-styrene (SIS), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated styrenic block copolymers, vinylacetate/polyethylene (EVA), or mixtures thereof.

In an eleventh aspect of the disclosure, which may be combined with any other aspect listed herein unless specified otherwise, the polymer-modified asphalt composition comprises a weight percent ratio of phenolic lipid-based compatibilizer to polymer additive [compatibilizer:additive] of from 1:5 to 1:1.

In a twelfth aspect of the disclosure, which may be combined with any other aspect listed herein unless specified otherwise, the phenolic lipid-based compatibilizer is devoid of carboxyl groups, carbonyl groups, or combinations thereof.

In a thirteenth aspect of the disclosure, which may be combined with any other aspect listed herein unless specified otherwise, the phenolic lipid-based compatibilizer is devoid of sterols, stanols, or combinations thereof.

In a fourteenth aspect of the disclosure, which may be combined with any other aspect listed herein unless specified otherwise, the phenolic lipid-based compatibilizer is extracted from a bio-based source material.

In a fifteenth aspect of the disclosure, which may be combined with any other aspect listed herein unless specified otherwise, the phenolic lipid-based compatibilizer comprises a liquid distillate extracted from a bio-based source material.

In a sixteenth aspect of the disclosure, which may be combined with any other aspect listed herein unless specified otherwise, the phenolic lipid-based compatibilizer has a molecular weight of less than 1,800 g/mol.

In a seventeenth aspect of the disclosure, which may be combined with any other aspect listed herein unless specified otherwise, the phenolic lipid-based compatibilizer has a molecular weight of from 300 to 900 g/mol.

In an eighteenth aspect of the disclosure, which may be combined with any other aspect listed herein unless specified otherwise, the phenolic lipid-based compatibilizer is a non-polymerized compatibilizer.

In a nineteenth aspect of the disclosure, which may be combined with any other aspect listed herein unless specified otherwise, the compatibilizer comprises cashew nut shell distillate, Cardol, Cardanol, derivatives thereof, or mixtures thereof.

In a twentieth aspect of the disclosure, which may be combined with any other aspect listed herein unless specified otherwise, the asphalt composition is devoid of recycled asphalt material.

In a twenty-first aspect of the disclosure, which may be combined with any other aspect listed herein unless specified otherwise, a roofing product comprising the asphalt composition is disclosed.

In a twenty-second aspect of the disclosure, which may be combined with any other aspect listed herein unless specified otherwise, a shingle comprising a sealant is disclosed, the sealant comprising the asphalt composition.

In a twenty-third aspect of the disclosure, which may be combined with any other aspect listed herein unless specified otherwise, a roofing underlayment comprising an asphalt adhesive layer is disclosed, the asphalt adhesive layer comprising the asphalt composition.

In a twenty-fourth aspect of the disclosure, which may be combined with any other aspect listed herein unless specified otherwise, a roofing underlayment comprising a core batch layer is disclosed, the core batch layer comprising the asphalt composition.

In a twenty-fifth aspect of the disclosure, which may be combined with any other aspect listed herein unless specified otherwise, a roofing underlayment comprising a single asphaltic layer is disclosed, the single asphaltic layer comprising the asphalt composition.

In a twenty-sixth aspect of the disclosure, which may be combined with any other aspect listed herein unless specified otherwise, a sealant comprising an asphalt composition is disclosed. The asphalt composition comprises: a polymer-modified asphalt material, the polymer-modified asphalt material comprising: from 10 to 99 wt. % of a base asphalt, based upon the total weight of the modified asphalt material; from 1 to 20 wt. % of a phenolic lipid-based compatibilizer, based upon the total weight of the modified asphalt material; and an amount up to 20 wt. % of a polymer additive, based upon the total weight of the modified asphalt material, wherein the sealant has a bond strength at 40° F. of 5 to 50 lbs. of force, as measured in accordance with modified ASTM D6381.

In a twenty-seventh aspect of the disclosure, which may be combined with any other aspect listed herein unless specified otherwise, a roofing underlayment comprising an asphalt composition is disclosed. The asphalt composition comprises: a modified asphalt material, the modified asphalt material comprising: from 10 to 99 wt. % of a base asphalt, based upon the total weight of the modified asphalt material; and from 1 to 20 wt. % of a phenolic lipid-based compatibilizer, based upon the total weight of the modified asphalt material, wherein the asphalt composition provides a bond strength at 40° F. of 1 to 10 lbs. of force to the roofing underlayment, as measured in accordance with ASTM D1970-21.

### DESCRIPTION OF THE FIGURES

The advantages of the inventive concepts will be apparent upon consideration of the following detailed disclosure, especially when taken in conjunction with the accompanying drawing wherein:

FIG. 1 represents the results of Example 3(a), studying the effect of compatibilizer concentration on SAU stick batch bond strength;

FIG. 2 represents the results of Example 3(b), studying the effect of the compatibilizer on SAU sticky batch asphalt viscosity;

FIG. 3 represents the results of Example 3(c), studying the effect of the compatibilizer on SAU sticky batch asphalt penetration value;

FIG. 4 represents the results of Example 3(d), studying the effect of the compatibilizer type on SAU sticky batch bond strength at 40° F.;

FIG. 5 represents the results of Example 3(e), studying the effect of the compatibilizer type on SAU sticky batch bond strength at 75° F.; and

FIG. 6 represents the results of Example 4, studying the effect of the compatibilizer on the bond strength of shingle sealants at 40° F.

### DETAILED DESCRIPTION

Disclosed herein are asphalt compositions comprising a phenolic lipid-based compatibilizer, as well as methods of making asphaltic products comprising the phenolic lipid-based compatibilizer. While the present disclosure describes certain embodiments of the compositions and methods in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The compositions and methods of the present disclosure can comprise, consist of, or consist essentially of the essential elements of the disclosure as described herein, as well as any additional or optional element described herein, or which is otherwise useful in asphaltic product applications.

An asphalt composition comprising a modified asphalt material is disclosed. The modified asphalt material comprises a base asphalt and a phenolic lipid-based compatibilizer. The asphalt composition exhibits an improved adhesion at temperatures of 40° F. or lower as compared to an otherwise identical asphalt composition devoid of the phenolic lipid-based compatibilizer. Roofing materials comprising the asphalt composition are likewise disclosed.

### Base Asphalt Materials

The asphalt compositions disclosed herein comprise a modified asphalt material. The term “modified asphalt” encompasses one or more base asphalt materials and optionally one or more additives. Unless otherwise clearly denoted herein, the modified asphalt material component is unfilled, and all weight percent values are indicated on an unfilled asphalt basis. Asphalt compositions further comprising fillers are detailed elsewhere in this disclosure.

As used herein, the term “asphalt” is meant to include any bituminous materials produced from petroleum refining, including residua from atmospheric distillation, from vacuum distillation, from solvent de-asphalting units, and from recycled asphalt streams, such as re-refined motor oil bottoms and extracted asphalt from recycled asphalt products. Mixtures of different asphalts can also be used. Some aspects disclosed herein can also be used with natural bitumen.

The asphalt may be visbroken and/or deasphalted (e.g., propane deasphalted asphalt). The asphalt may be fully oxidized, or partially oxidized. Alternatively, the asphalt may be non-oxidized. The asphalt may be prepared using a wide array of paving grade asphalt materials, such as different types of paving asphalts used independently or as a mixture with various types of asphalt, such as, for example, solvent extracted asphalt, naturally occurring asphalt, synthetic asphalt, and recycled asphalt. The various asphalt bases can be combined with one another in order to obtain the best technical compromise.

The base asphalt may comprise one or more of roofing flux, paving grade asphalt or paving grade asphalt blends, propane deasphalted asphalt, partially or fully oxidized asphalt, non-oxidized asphalt, or blends thereof. The base asphalt may comprise paving grade asphalt, oxidized asphalt, non-oxidized asphalt, or mixtures thereof.

The base asphalt may include at least one type of paving-grade asphalt. As used herein, the term “paving grade asphalt” indicates a performance grade asphalt according to AASHT20 17320-17 that has a softening point within the range of 60° F. to 130° F. and a penetration value of at least 25 decimillimeter (dmm), as measured in accordance with ASTM D5. Any suitable paving-grade asphalt(s) can be used, for example paving asphalts which meet the PG 64-22 specifications (AASHTO M320 or AASHTO M332). Paving asphalts were previously graded by viscosity, and a common asphalt that is similar to the PG 64-22 grade asphalt and also usable in this method, is the old AC20 grade asphalt (ASTM D 3381). Other examples of suitable paving-grade asphalts include PG 52-28, PG 46-34, PG 67-22, PG 70-22, PG 58-28, PG 58-22, PG 70-16, PG 70-10, PG 67-10, pen grade 40/50, pen grade 60/70, pen grade 85/100, pen grade 120/150, pen grade 150/200, AR4000, AR8000, and AC/30 grade.

The modified asphalt material comprises an amount up to 99 wt. % of the base asphalt, based upon the total weight of the modified asphalt material, including an amount up to 97 wt. %, including an amount up to 95 wt. %, including an amount up to 93 wt. %, including an amount up to 90 wt. %, including an amount up to 88 wt. %, including an amount up to 85 wt. %, including an amount up to 83 wt. %, including an amount up to 80 wt. %, including an amount up to 77 wt. %, including an amount up to 75 wt. %, including an amount up to 70 wt. %, including an amount up to 65 wt. %, including an amount up to 60 wt. %, including an amount up to 50 wt. %. The modified asphalt material comprises at least 10 wt. % of the base asphalt, based upon the total weight of the modified asphalt material, including at least 15 wt. %, including at least 20 wt. %, including at least 25 wt. %, including at least 30 wt. %, including at least 40 wt. %. The modified asphalt material comprises from 10 to 99 wt. % of the base asphalt, including from 45 to 97 wt. %, including from 70 to 95 wt. %, including an amount from 10 to 90 wt. %, including an amount from 45 to 90 wt. %, including an amount from 70 to 90 wt. %, including from 15 to 75 wt. %, including from 10 to 60 wt. %, including from 20 to 70 wt. %, including from 25 to 65 wt. %, including from 30 to 60 wt. %, including from 40 to 50 wt. %, based upon the total weight of the modified asphalt material. All weight percent values in this passage are indicated on an unfilled asphalt basis.

### Phenolic Lipid-Based Compatibilizers

A phenolic lipid-based compatibilizer is disclosed. The phenolic lipid-based compatibilizer provides improved adhesion at temperatures of 40° F. or lower to the asphalt composition, as compared to an otherwise identical asphalt composition devoid of the phenolic lipid-based compatibilizer.

In general, the phenolic lipid-based compatibilizer is derived from a bio-based source material. The term “bio-based” is intended to be used herein interchangeably with the term “plant-based,” i.e., to indicate materials that are not synthesized or otherwise derived from nonrenewable fossil fuel feedstocks such as coal or petroleum. More specifically, the phenolic lipid-based compatibilizer is extracted from a bio-based source material, and may comprise a liquid distillate extracted from the bio-based source material. Thus, the phenolic lipid-based compatibilizer may comprise a distillation residue obtained from the distillation or extraction from, for instance, cashew nut shell oil.

The phenolic lipid-based compatibilizer may comprise an aromatic group with one, or two, or more hydroxy groups and an aliphatic tail group. The compatibilizer may consist of a phenolic lipid. The phenolic lipid-based compatibilizer may be functionalized, i.e., functional groups may be added or otherwise modified to manipulate aspects of the compatibilizer's performance. For example, it may be desirable to modify the phenolic lipid-based compatibilizer so as to avoid crosslinking with other additives that may be present in the asphalt composition. The phenolic lipid-based compatibilizer may include modifications to the functional groups on any double bonds, or of the aromatic hydroxyl groups. Non-limiting examples of modifications include the addition of organic or inorganic functional groups, including, without limitation, alcohol groups, amine groups, amide groups, epoxy groups, esterified derivatives, and grafted oligomers. That said, the subject phenolic lipid-based compatibilizer excludes the modifications of added carboxyl groups, carbonyl groups, or combinations thereof.

The phenolic lipid-based compatibilizer may comprise, or consist of, cashew nut shell distillate, Cardol, Cardanol, derivatives thereof, or mixtures thereof. The phenolic lipid-based compatibilizer is distinct from cashew nut shell liquid (“CNSL”) i.e., CNSL constitutes an upstream source product from which the disclosed phenolic lipid-based compatibilizer may be selectively extracted. The phenolic lipid-based compatibilizer may be free of (i.e., devoid of) carboxyl groups, carbonyl groups, or combinations thereof. The phenolic lipid-based compatibilizer may be free of sterols, stanols, or combinations thereof. The phenolic lipid-based compatibilizer may be free of anacardic acid.

The phenolic lipid-based compatibilizer is a non-polymerized compatibilizer. The phenolic lipid-based compatibilizer has a molecular weight of less than 1,800 g/mol, including less than 1,500 g/mol, including less than 1,000 g/mol, including less than 900 g/mol, including less than 500 g/mol, including less than 400 g/mol, including a molecular weight of from 100 to 1,800 g/mol, including from 150 to 1,500 g/mol, including from 300 to 900 g/mol, including from 250 to 500 g/mol, including from 275 to 400 g/mol, including from 300 to 320 g/mol.

The phenolic lipid-based compatibilizer is environmentally friendly and preferably has a global warming potential (“GWP”) that is less than 5 kg CO₂e (“CO₂ equivalents”). The phenolic lipid-based compatibilizer may have a GWP that is no greater than 2 kg CO₂e, or no greater than 1.5 CO₂e, or no greater than 1.25 CO₂e, or no greater than 1 CO₂e. The phenolic lipid-based compatibilizer may include, for example, a GWP between −5 CO₂e and 5 CO₂e, including between −2.5 CO₂e and 2.5 CO₂e, between −1.5 CO₂e and 2 CO₂e, between −1 CO₂e and 1.5 CO₂e, or between −0.5 CO₂e and 1 CO₂e.

The modified asphalt material comprises an amount up to 20 wt. % of the phenolic lipid-based compatibilizer, including up to 15 wt. %, including up to 10 wt. %, including up to 8 wt. %, including up to 7.5 wt. %, including up to 5 wt. %, including from 1 to 20 wt. % of the phenolic lipid-based compatibilizer, including from 1.25 to 15 wt. %, including from 1.5 to 10 wt. %, including from 2 to 8 wt. %, including from 2.25 to 7.5 wt. %, including from 2.5 to 5 wt. %, including from 3 to 5 wt. % of the phenolic lipid-based compatibilizer, based upon the total weight of the modified asphalt material. All weight percent values in this passage are indicated on an unfilled asphalt basis.

### Polymer-Modified Asphalt Compositions

The modified asphalt material may further comprise one or more polymer additives. Accordingly, the modified asphalt material may be a polymer-modified asphalt material.

The polymer additive may comprise an elastomeric radial and/or linear polymer. The polymer additive may comprise a copolymer such as a linear or radial copolymer. The polymer additive may comprise one or more of atactic polypropylene (APP), isotactic polypropylene (IPP), styrene-butadiene-styrene rubber (SBS), polychloroprene; polynorbornene; chloroprene rubber (CR), natural and reclaimed rubbers (including ground tire rubber (GTR), devulcanized ground tire rubber, and devulcanized GTR), butadiene rubber (BR), acrylonitrile-butadiene rubber (NBR), isoprene rubber (IR), styrene-isoprene, styrene-polyisoprene-styrene (SIS), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated styrenic block copolymers, vinylacetate/polyethylene (EVA), ethylene-methylacrylate copolymers (EMA), copolymers of olefins and unsaturated carboxylic esters such as ethylene-butylacrylates (EBA), polyolefinic copolymers, polyolefins such as polybutenes (PB), copolymers of ethylene and esters of acrylic acid or methacrylic acid or maleic anhydride, copolymers and terpolymers of ethylene and glycidyl methacrylate, ethylene/propylene copolymers, rubber, and mixtures thereof. The polymer additive may comprise a linear polymer or a combination of linear and radial polymers. Examples of polymer modifiers are also disclosed in U.S. Pat. No. 4,738,884 to Algrim et al., U.S. Pat. No. 3,770,559 to Jackson, and U.S. Pat. No. 11,028,591 to LaTorre et al., the contents of which are incorporated herein by reference in their entirety. The one or more polymer additives may comprise, or consist of, styrene-butadiene block copolymer (SBS).

The polymer-modified asphalt material comprises an amount up to 20 wt. % of the one or more polymer additives, including up to 15 wt. %, including up to 12 wt. %, including up to 10 wt. %, including up to 7 wt. %, including up to 6.5 wt. %, including up to 6 wt. %, including from 1 to 20 wt. % of the one or more polymer additives, including from 1 to 15 wt. %, including from 6 to 15 wt. %, including from 1.5 to 12 wt. %, including from 1.75 to 10 wt. %, including from 2 to 7 wt. %, including from 2.5 to 6.5 wt. %, including from 3 to 6 wt. % of the one or more polymer additives, based upon the total weight of the polymer-modified asphalt material. All weight percent values in this passage are indicated on an unfilled asphalt basis.

It has been surprisingly found that a particular ratio of phenolic lipid-based compatibilizer to polymer additive within the polymer-modified asphalt material contributes to the improvements in low temperature adhesion. The polymer-modified asphalt material may comprise a weight percent ratio of phenolic lipid-based compatibilizer to polymer additive [compatibilizer:additive] of from 1:5 to 1:1, including from 1:4 to 1:1, including from 1:3 to 1:1, including from 1:2 to 1:1, including a weight percent ratio of 1:1, including a weight percent ratio of 1:5.

### Asphalt Additives

The modified asphalt material may include further components in addition to the asphalt and the phenolic lipid-based compatibilizer.

The modified asphalt material may further include one or more hardeners. Such hardeners may include, for example, a modified pine resin, modified pine rosin, tall pitch oil, and mixtures thereof. The modified pine resin and/or modified pine rosin may be esterified. The hardener may have an acid value of from 0 mEq KOH to 30 mEq KOH, including from 5 mEq KOH to 30 mEq KOH, including from 5 mEq KOH to 25 mEq KOH, including from 10 mEq KOH to 25 mEq KOH, including from 10 mEq KOH to 20 mEq KOH, including from 10 mEq KOH to 15 mEq KOH.

The modified asphalt material may comprise an amount up to 15 wt. % of the one or more hardeners, including from 0.5 to 15 wt. % of the one or more hardeners, including from 1 to 12 wt. %, including from 1.5 to 10 wt. %, including from 1.75 to 9 wt. %, including from 1.8 to 8 wt. %, including from 2 to 7.5 wt. % of the one or more hardeners, based upon the total weight of the modified asphalt material. All weight percent values in this passage are indicated on an unfilled asphalt basis.

The modified asphalt material may further include a wax. Any type of wax, or a mixture of different waxes, capable of functioning as described herein can be used in the modified asphalt material. For example, the wax may comprise one or more of a paraffin wax and a non-paraffin wax. Paraffin waxes typically have melting points below 70° C. and have less than 45 carbon atoms. Non-paraffin waxes typically have melting points above 70° C. and have more than 45 carbon atoms. The non-paraffin wax may be one or more of a natural wax, a modified natural wax, a partial synthetic wax, and a full synthetic wax. Non-limiting examples of suitable partial and fully synthetic waxes include ethylene bis-stearamide wax (EBS), Fischer-Tropsch wax (e.g., SASOBIT™), stearic acid pitch, polyolefin waxes such as oligomerized or depolymerized polyolefins, polyethylene wax (PE), oxidized polyethylene wax (PEO), polypropylene wax, polyethylene terephthalate (PET) waxes, and polypropylene/polyethylene wax; alcohol wax, silicone wax, petroleum waxes such as microcrystalline wax, chlorinated wax, acrylic waxes, and combinations thereof. Any suitable mixtures of different waxes can also be used. For example, the wax may include a blend of a Fischer-Tropsch wax and a polyethylene wax. The waxes may be recycled, reclaimed, or virgin waxes. For example, the wax may be a recycled, reclaimed, or virgin polyethylene or polypropylene wax. Other recycled waxes, such as recycled nylon and acrylic may be used.

The modified asphalt material may comprise an amount up to 10 wt. % of the wax, including from 0.5 to 10 wt. % of the wax, including from 1 to 9 wt. %, including from 2 to 8.5 wt. %, including from 3 to 8 wt. %, including from 3.5 to 7.5 wt. %, including from 4 to 5 wt. % of the wax, based upon the total weight of the modified asphalt material. All weight percent values in this passage are indicated on an unfilled asphalt basis.

The modified asphalt material may further include recycled or reclaimed asphalt material. The reclaimed asphalt material can include, for example, asphalt extracted from recycled roofing products, including asphalt extracted from recycled asphalt shingles (“RAS”). The reclaimed asphalt material may include greater than 50 wt. % asphalt content, including greater than 55 wt. %, including greater than 60 wt. %, including greater than 65 wt. %, including greater than 70 wt. %, including greater than 75 wt. %, based on the total weight of the reclaimed asphalt material.

When reclaimed asphalt material is included in the modified asphalt material, the modified asphalt material may comprise an amount up to 70 wt. % of the reclaimed asphalt material, including up to 60 wt. %, including up to 50 wt. %, including up to 40 wt. %, including up to 30 wt. %, including up to 20 wt. % of reclaimed asphalt material. All weight percent values in this passage are indicated on an unfilled asphalt basis.

That said, it should be understood that the inclusion of reclaimed asphalt material is optional and, accordingly, the modified asphalt material may be devoid of reclaimed (i.e., recycled) asphalt material.

Conversely, the modified asphalt material may comprise greater than 75 wt. %, including greater than 80 wt. %, including greater than 85 wt. %, including greater than 90 wt. %, including greater than 95 wt. %, including 100 wt. % reclaimed asphalt material, in which case the modified asphalt material includes trace amounts of virgin asphalt material, or is devoid of virgin asphalt material. All weight percent values in this passage are indicated on an unfilled asphalt basis.

### Asphalt Filler

In addition to the modified asphalt material, the asphalt composition as a whole may further include a filler material. The filler material may include particles comprising any variety of ground inorganic particulate matter, such as, for example, ground limestone, dolomite or silica, talc, sand, cellulosic materials, fiberglass, calcium carbonate, clay, carbon, perlite, mica, fumed silica, carbon black, wollastonite, and combinations thereof. The filler material may comprise particles having an average (median) particle size in the range of 0.3 microns to 200 microns, including an average particle size range of 1 micron to 180 microns, including 5 microns to 175 microns, including 25 microns to 125 microns, including 35 microns to 100 microns, 40 microns to 85 microns.

The asphalt composition may comprise an amount up to 70 wt. % of the filler material, including from 10 to 65 wt. % of the filler material, including from 15 to 60 wt. %, including from 20 to 70 wt. %, including from 30 to 60 wt. %, including from 40 to 60 wt. %, including from 50 to 60 wt. % of the filler material, including from 10 to 40 wt. % of the filler material, including from 20 to 40 wt. % of the filler material, based upon the total weight of the filled asphalt composition.

### Asphaltic Products

Roofing products comprising an asphalt composition are disclosed herein.

The asphalt composition may be used as an adhesive or coating on substrates for use in the manufacture of shingles and other roofing products, such as roofing underlayments, membranes, roll roofing, and the like. When the asphalt composition constitutes a coating on a roofing material, the asphalt composition may be applied to at least a portion of a substrate. The substrate can be any type known for use in asphalt-based roofing materials, such as a web, woven or nonwoven material, coated woven or coated nonwoven, polymeric film, scrim or felt of fibrous materials such as mineral fibers, fiberglass, cellulose fibers, rag fibers, PET fibers, mixtures of mineral and synthetic fibers, or the like. Combinations of materials can also be used in the substrate. The substrate may be a nonwoven web of glass fibers. The substrate may be any conventional substrate used in asphalt shingles, roll roofing, low-slope membranes, and the like.

A shingle comprising a sealant is disclosed herein, wherein the sealant comprises an asphalt composition including a phenolic lipid-based compatibilizer. With respect to shingles, the terms “adhesive” and “sealant” are used interchangeably herein. A conventional roofing shingle is typically constructed of a substrate, an asphalt coating composition that saturates the substrate and forms a layer of asphalt coating on a top surface and a bottom surface of the substrate, a decorative/protective layer of granules applied to the asphalt coating on the top surface of the substrate, and optionally, a layer of sand or other parting agent applied to the asphalt coating on the bottom surface of the substrate. An adhesive or sealant is then placed on the shingles to bond together successive layers of shingles during installation.

A roofing underlayment comprising an asphalt composition is disclosed herein, wherein the asphalt composition includes a phenolic lipid-based compatibilizer. In general, a roofing membrane, such as a roofing underlayment, is a water-resistant sheet installed on a roof deck prior to installing shingles or other coverings on the roof. The roofing underlayment may comprise a multi-layer structure. One layer may include a core asphalt composition (optionally either coated on, or impregnated in, a glass reinforcement layer). One layer may include an adhesive asphalt composition (“sticky batch”) layer. The underlayment may include both a core asphalt layer and a sticky batch layer. The underlayment may instead only include a single asphaltic layer. Other optional layers of the underlayment may include a polymeric facer on the top of the core asphalt composition, a polymeric film disposed between the glass layer and the sticky batch layer (such as a high-density polyethylene film), and/or a release liner on the bottom, which is removed before application to a roof.

Accordingly, a roofing underlayment comprising an asphalt adhesive layer is disclosed herein, wherein the asphalt adhesive (sticky batch) layer comprises an asphalt composition including a phenolic lipid-based compatibilizer. Alternatively, or additionally, a roofing underlayment comprising a core batch layer is disclosed herein, wherein the core batch layer comprises an asphalt composition including a phenolic lipid-based compatibilizer. Alternatively, or additionally, a roofing underlayment comprising a single asphaltic layer is disclosed herein, wherein the single asphaltic layer comprises an asphalt composition including a phenolic lipid-based compatibilizer.

### Ranges of Ingredients

Tables 1 and 2 show exemplary ranges of ingredients for exemplary roofing products comprising an asphalt composition including a phenolic lipid-based compatibilizer. All weight percent values for the modified asphalt material are indicated on an unfilled asphalt basis. In any of the embodiments disclosed herein, the asphalt composition may comprise, consist essentially of, or consist of the ingredients of Tables 1 or 2. It is to be appreciated that any individual range from Ranges 1, 2, and 3 may be combined with any other compositional range(s) of Ranges 1, 2, and 3 in Tables 1 and 2 below.

TABLE 1

| Shingle Sealant Products | | | | | |
|---|---|---|---|---|---|
| | Exemplary | Particular | Ranges of Ingredients (wt. %) * | | |
| Classification | Ingredients | Embodiments | Range 1 | Range 2 | Range 3 |
| Modified | Base Asphalt | Paving Grade Asphalt, | 10-99 | 45-97 | 70-95 |
| Asphalt | | Non-Paving Grade | | | |
| Material | | Asphalt, Oxidized | | | |
| | | Asphalt, Non-Oxidized | | | |
| | | Asphalt, or mixtures | | | |
| | | thereof | | | |
| | Phenolic | Cardanol, Cardol, | 1-20 | 2-8 | 3-5 |
| | Lipid-Based | mixtures thereof, or | | | |
| | Compatibilizer | functionalized | | | |
| | | derivatives thereof | | | |
| | Polymer | Linear polymer, radial | Optional | 1-15 | 2-7 |
| | Additives | polymer, other polymers, | | | |
| | | or mixtures thereof | | | |
| Filler | Conventional | Calcium carbonate, | Optional | 10-40 | 20-40 |
| | Asphalt Filler | dolomite, other minerals, | | | |
| | materials | or mixtures thereof | | | |

* The modified asphalt material ingredients are indicated on an unfilled asphalt basis.

TABLE 2

| Self-Adhered Underlayment Products | | | | | |
|---|---|---|---|---|---|
| | Exemplary | Particular | Ranges of Ingredients (wt. %) * | | |
| Classification | Ingredients | Embodiments | Range 1 | Range 2 | Range 3 |
| Modified | Base Asphalt | Paving Grade Asphalt, | 10-99 | 45-97 | 70-95 |
| Asphalt | | Asphalt Flux, or | | | |
| Material | | mixtures thereof | | | |
| | Phenolic | Cardanol, Cardol, | 1-20 | 2-8 | 3-5 |
| | Lipid-Based | mixtures thereof, or | | | |
| | Compatibilizer | functionalized | | | |
| | | derivatives thereof | | | |
| | Polymer | Linear polymer, radial | Optional | 1-20 | 6-15 |
| | Additives | polymer, other polymers, | | | |
| | | or mixtures thereof | | | |
| Filler | Conventional | Limestone | Optional | 10-40 | 20-40 |
| | Asphalt Filler | | | | |
| | materials | | | | |

* The modified asphalt material ingredients are indicated on an unfilled asphalt basis.

### Performance of the Asphaltic Products

As set forth previously, it has been surprisingly found that the phenolic lipid-based compatibilizer provides an improved adhesion at temperatures of 40° F. or lower to an asphalt composition. Specifically, it has been found that asphalt compositions comprising the phenolic lipid-based compatibilizer exhibit an improved bond strength at 40° F. as compared to otherwise identical asphalt composition devoid of the phenolic lipid-based compatibilizer.

In some aspects, a shingle comprising a sealant, wherein the sealant comprises an asphalt composition including a phenolic lipid-based compatibilizer, has a bond strength at 40° F. of 5 to 50 lbs. of force, including a bond strength at 40° F. of 5 to 30 lbs., including a bond strength at 40° F. of 10 to 30 lbs., as measured in accordance with ASTM D6381 (“Standard Test Method for Measurement of Asphalt Shingle Mechanical Uplift Resistance”). Notably, the sealant bond force was measured with a modification to a higher 12 in/min testing speed, as opposed to the ASTM D6381 standard 5 in/min testing speed. In accordance with ASTM D6381, the conditioning time was 48 hours, the conditioning temperature was 40° F., and the test temperature was 40° F. Accordingly, ASTM D6381, as used herein, will be referred to as “modified ASTM D6381”.

In some aspects, a roofing underlayment comprising an asphalt adhesive layer, wherein the asphalt adhesive layer comprises an asphalt composition including a phenolic lipid-based compatibilizer, has a bond strength at 40° F. of 1 to 10 lbs. of force, including greater than 2 lbs., including a bond strength at 40° F. of 2 to 4 lbs., including a bond strength at 40° F. of 3 to 4 lbs., as measured in accordance with ASTM D1970-21 (“Standard Specification for Self-Adhering Polymer Modified Bituminous Sheet Materials Used as Steep Roofing Underlayment for Ice Dam Protection”), specifically with respect to Section 7.4 (“Adhesion to Plywood”).

Further, it has been found that asphalt compositions comprising the phenolic lipid-based compatibilizer exhibit an improved penetration value at 77° F. as compared to otherwise identical asphalt composition devoid of the phenolic lipid-based compatibilizer. Specifically, an asphalt composition comprising the phenolic lipid-based compatibilizer has a penetration value at 77° F. of 20 to 180 dmm, as measured in accordance with ASTM D5, including a penetration value at 77° F. of 50 to 175 dmm, including a penetration value at 77° F. of 60 to 150 dmm, including a penetration value at 77° F. of 60 dmm or greater, including a penetration value at 77° F. of 65 dmm or greater, including a penetration value at 77° F. of 70 dmm or greater, including a penetration value at 77° F. of 75 dmm or greater.

In some aspects, a shingle comprising a sealant, wherein the sealant comprises an asphalt composition including a phenolic lipid-based compatibilizer, has a penetration value at 77° F. of 20 to 180 dmm, as measured in accordance with ASTM D5, including a penetration value at 77° F. of 20 to 100 dmm, including a penetration value at 77° F. of 20 to 50 dmm, including a penetration value at 77° F. of 20 to 40 dmm, including a penetration value at 77° F. of 20 dmm or greater.

In some aspects, a roofing underlayment comprising an asphalt adhesive layer, wherein the asphalt adhesive layer comprises an asphalt composition including a phenolic lipid-based compatibilizer, has a penetration value at 77° F. of 20 to 180 dmm, as measured in accordance with ASTM D5, including a penetration value at 77° F. of 50 to 175 dmm, including a penetration value at 77° F. of 60 to 150 dmm, including a penetration value at 77° F. of 60 dmm or greater, including a penetration value at 77° F. of 65 dmm or greater, including a penetration value at 77° F. of 70 dmm or greater, including a penetration value at 77° F. of 75 dmm or greater.

Further, it has been found the asphalt compositions comprising the phenolic lipid-based compatibilizer exhibit an improved (i.e., lower) viscosity as compared to the otherwise identical asphalt composition devoid of the compatibilizer. Specifically, an asphalt composition comprising the phenolic lipid-based compatibilizer exhibits an improved viscosity at temperatures of 325° F. or higher, as compared to an otherwise identical asphalt composition devoid of the phenolic lipid-based compatibilizer. As used herein, the viscosity of an asphalt composition is determined under the standards of ASTM D4402-23 (“Standard Test Method for Viscosity Determination of Asphalt at Elevated Temperatures Using a Rotational Viscometer”).

In accordance with the present disclosure, it is possible to utilize the various inventive concepts in combination with one another. Additionally, any particular feature recited as relating to a particularly disclosed aspect of the methods and systems of the present disclosure should be interpreted as available for use with all disclosed aspects of the methods and systems of the present disclosure, unless incorporation of the particular feature would be contradictory to the express terms of the disclosed aspect. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

### EXAMPLES

The following examples are included for the purposes of illustration, and do not limit the scope of the general inventive concepts described herein.

### Example 1

### Example 1 (a): Effect of Compatibilizer on Asphalt Penetration Value

A study was conducted to evaluate the impact of the subject compatibilizer on the penetration value of asphalt compositions at 77° F. The penetration value of the respective asphalt compositions was used as a corollary for assessing the low temperature adhesion performance (i.e., at 40° F. or below) of the respective compositions. Specifically, a higher penetration value correlates with improved adhesion. In contrast, an asphalt composition with a penetration value that is two low will not flow around the substrate, and accordingly, adhesion performance decreases.

In this study, two asphalt compositions comprising a phenolic lipid-based compatibilizer constituting a liquid distillate extracted from a cashew nut shell liquid, i.e., Cardanol (“Compatibilizer A”) were prepared, for the purposes of comparison against an otherwise identical asphalt composition not including a compatibilizer. All of the asphalt compositions included an identical base asphalt. The two exemplary asphalt compositions (Sample 2.5A and Sample 5A) comprised the compatibilizer Cardanol in amounts of 2.5 wt. % or 5 wt. %, respectively, based upon the total weight of the asphalt composition. The comparative asphalt composition (Comparative Sample) was otherwise identical but did not include any compatibilizer.

The penetration value of each sample was assessed under the standards of ASTM D5M-20 (“Standard Test Method for Penetration of Bituminous Materials”) and is provided in Table 3 below.

TABLE 3

| | Asphalt Sample | | |
|---|---|---|---|
| | Comparative | Sample 2.5A | Sample 5A |
| | (No | (2.5 wt. % | (5 wt. % |
| | Compatibilizer) | Compatibilizer) | Compatibilizer) |
| Penetration at | 48 | 80 | 123 |
| 77° F. (dmm) | | | |

As shown in Table 3, the asphalt compositions comprising Compatibilizer A exhibited an improved penetration value at 77° F. as compared to the otherwise identical asphalt composition devoid of the compatibilizer.

### Example 1 (b): Effect of Compatibilizer on Asphalt Viscosity

Each of the samples from Example 1 (a) (i.e., the Comparative Sample with no compatibilizer, Sample 2.5A comprising 2.5 wt. % of Compatibilizer A, and Sample 5A comprising 5 wt. % of Compatibilizer A) were further studied to evaluate the impact of the subject compatibilizers on the viscosity of asphalt compositions at various temperatures.

The viscosity of each sample was assessed under the standards of ASTM D4402 (“Standard Test Method for Viscosity Determination of Asphalt at Elevated Temperatures Using a Rotational Viscometer”), and is provided in Table 4 below.

TABLE 4

| | Asphalt Sample | | |
|---|---|---|---|
| | Comparative | Sample 2.5A | Sample 5A |
| | (No | (2.5 wt. % | (5 wt. % |
| | Compatibilizer) | Compatibilizer) | Compatibilizer) |
| Viscosity at | 1200 | 855 | 648 |
| 325° F. (cP) | | | |
| Viscosity at | 703 | 548 | 425 |
| 350° F. (cP) | | | |
| Viscosity at | 455 | 370 | 290 |
| 375° F. (cP) | | | |
| Viscosity at | 313 | 263 | 200 |
| 400° F. (cP) | | | |

As shown in Table 4, the asphalt compositions comprising Compatibilizer A exhibited an improved (i.e., lower) viscosity at each studied temperature as compared to the otherwise identical asphalt composition devoid of the compatibilizer.

### Example 2

A study was conducted to evaluate the particular phenolic lipid-based compatibilizer constituting a liquid distillate extracted from a cashew nut shell liquid, i.e., Cardanol (“Compatibilizer A”) utilized in Example 1, as compared to a sample constituting cashew nut shell liquid (CNSL, “Comparative Sample B”), i.e., the upstream source material from which Compatibilizer A is selectively extracted during manufacturing. The compounds differ structurally in that CNSL (Comparative Sample B) contains sterols and a mix of other cashew nut shell components, whereas Cardanol (Compatibilizer A) is devoid of sterols.

Specifically, two asphalt compositions comprising Cardanol (Compatibilizer A) were prepared as described in Example 1, for the purposes of comparison to two asphalt compositions comprising CNSL (Comparative Sample B). All of the asphalt compositions included an identical base asphalt. The asphalt compositions comprised the compatibilizers in amounts of 2.5 wt. % or 5 wt. %, respectively, based upon the total weight of the asphalt composition.

As in Example 1, the impact of the subject compatibilizers on the both the penetration value of asphalt compositions at 77° F. as measured in accordance with ASTM D5 and the viscosity under the standards of ASTM D4402 at varying temperatures were studied, with the penetration value of the respective asphalt compositions used as a corollary for assessing the low temperature adhesion performance (i.e., at 40° F. or below) of the respective compositions. In addition, the softening point of each respective asphalt compositions was measured. The softening point of each sample was assessed under the standards of ASTM D36-06 (“Standard Test Method for Softening Point of Bitumen”).

TABLE 5

| | Asphalt Sample | | | |
|---|---|---|---|---|
| | | Comparative | | Comparative |
| | Sample 2.5A | Sample 2.5B | Sample 5A | Sample 5B |
| | (Cardanol) | (CNSL) | (Cardanol) | (CNSL) |
| Penetration at | 80 | 65 | 123 | 96 |
| 77° F. (dmm) | | | | |
| Viscosity at | 855 | 945 | 648 | 755 |
| 325° F. (cP) | | | | |
| Viscosity at | 548 | 610 | 425 | 510 |
| 350° F. (cP) | | | | |
| Viscosity at | 370 | 433 | 290 | 355 |
| 375° F. (cP) | | | | |
| Viscosity at | 263 | 305 | 200 | 233 |
| 400° F. (cP) | | | | |
| Softening | 186 | 180 | 176 | 172 |
| Point (° F.) | | | | |

As shown in Table 5 above, at both the 2.5 wt. % and 5 wt. % loading values, the asphalt compositions comprising Compatibilizer A (Cardanol) exhibited an improved penetration value at 77° F. than those comprising Compatibilizer B (CNSL). Likewise, at both the 2.5 wt. % and 5 wt. % loading values, the asphalt compositions comprising Compatibilizer A (Cardanol) exhibited an improved (i.e., lower) viscosity at each studied temperature as compared to the otherwise identical asphalt compositions comprising Compatibilizer B (CNSL). Finally, at both the 2.5 wt. % and 5 wt. % loading values, the asphalt compositions comprising Compatibilizer B (CNSL) exhibited a worse (i.e., lower) softening point as compared to the otherwise identical asphalt compositions comprising Compatibilizer A (Cardanol).

### Example 3

### Example 3(a): Effect of Compatibilizer Concentration on SAU Sticky Batch Bond Strength

A study was conducted to evaluate the impact of the subject compatibilizer on the adhesion performance at low temperatures (40° F.) of asphalt adhesive (“sticky batch”) formulations for use in self-adhered roofing underlayment (SAU) products.

In this study, two Classes, each containing three asphalt adhesive samples were prepared. The samples of Class 1 included a base asphalt containing 9 wt. % paving grade asphalt and 82 wt. % roofing flux, whereas the samples of Class 2 included a base asphalt containing 14 wt. % paving grade asphalt and 77 wt. % roofing flux. All weight percent values in this Example are indicated on an unfilled asphalt basis. Within each Class, two asphalt adhesive samples comprising a phenolic lipid-based compatibilizer constituting a liquid distillate extracted from a cashew nut shell liquid, i.e., Cardanol (“Compatibilizer A”) were prepared, for the purposes of comparison against an otherwise identical asphalt adhesive composition not including a compatibilizer. The two exemplary asphalt adhesives (Sample 2A and Sample 4A) comprised the compatibilizer Cardanol in amounts of 2 wt. % or 4 wt. %, respectively, based upon the total weight of the modified asphalt material. The comparative asphalt adhesive (“No Oil”) was otherwise identical but did not include any compatibilizer.

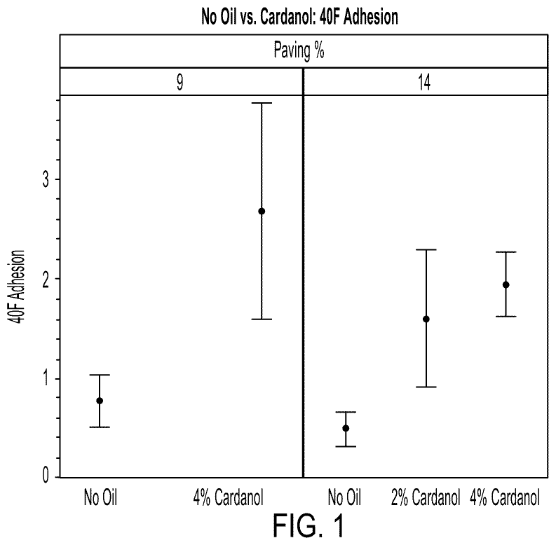

The bond strength of each respective asphalt adhesive was assessed at 40° F. under the standards of ASTM D1970-21 (“Standard Specification for Self-Adhering Polymer Modified Bituminous Sheet Materials Used as Steep Roofing Underlayment for Ice Dam Protection”), specifically with respect to Section 7.4 (“Adhesion to Plywood”), and is provided in FIG. 1.

As shown in FIG. 1, the asphalt adhesive compositions comprising Compatibilizer A exhibited an improved (i.e., higher bond strength) cold weather adhesion performance as compared to the otherwise identical asphalt adhesive compositions devoid of the compatibilizer. This result was observed at both Classes of 9 wt. % and 15 wt. % paving grade asphalt loading, respectively.

### Example 3(b): Effect of Compatibilizer on SAU Sticky Batch Asphalt Viscosity

A study was conducted to evaluate the impact of the compatibilizer type on the viscosity of asphalt compositions at various temperatures. Specifically, the purpose of this study was to evaluate the particular phenolic lipid-based compatibilizer constituting a liquid distillate extracted from a cashew nut shell liquid, i.e., Cardanol (“Compatibilizer A”), as compared to hydrolene, a conventional petroleum-based compatibilizer oil used in asphalt adhesive (“sticky batch”) formulations (i.e., “Compatibilizer C”).

An asphalt adhesive composition comprising Cardanol (Compatibilizer A) was prepared for the purposes of comparison to an asphalt adhesive composition comprising conventional Compatibilizer C. Both of the asphalt adhesive compositions included an identical base asphalt comprising 100% roofing flux, together with identical polymer additives and asphalt fillers. The asphalt adhesive compositions comprised the respective compatibilizers in an amount of 4 wt. %, based upon the total weight of the asphalt adhesive composition on an unfilled basis.

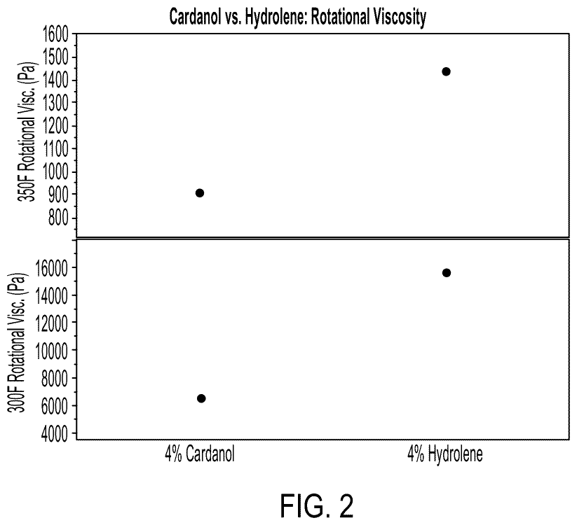

The viscosity of each sample was assessed under the standards of ASTM D4402 (“Standard Test Method for Viscosity Determination of Asphalt at Elevated Temperatures Using a Rotational Viscometer”) and is provided in FIG. 2.

As shown in FIG. 2, the asphalt adhesive compositions comprising Compatibilizer A (Cardanol) exhibited an improved (i.e., lower) viscosity at both 300° F. and 350° F., as compared to the otherwise identical asphalt compositions comprising Compatibilizer C (hydrolene).

### Example 3(c): Effect of Compatibilizer on SAU Sticky Batch Asphalt Penetration Value

A study was conducted to evaluate the impact of the subject compatibilizer on the penetration value of asphalt compositions at 77° F., as measured in accordance with ASTM D5. Specifically, similar to Example 3(b), the purpose of this study was to evaluate the particular phenolic lipid-based compatibilizer constituting a liquid distillate extracted from a cashew nut shell liquid, i.e., Cardanol (“Compatibilizer A”), as compared to hydrolene, a conventional petroleum-based compatibilizer oil used in asphalt adhesive (“sticky batch”) formulations (i.e., “Compatibilizer C”).

An asphalt adhesive composition comprising Cardanol (Compatibilizer A) was prepared for the purposes of comparison to an asphalt adhesive composition comprising conventional Compatibilizer C (hydrolene). Both of the asphalt adhesive compositions included an identical base asphalt comprising 100% roofing flux, together with identical polymer additives and asphalt fillers. The asphalt adhesive compositions comprised the respective compatibilizers in an amount of 4 wt. %, based upon the total weight of the asphalt adhesive composition on an unfilled basis.

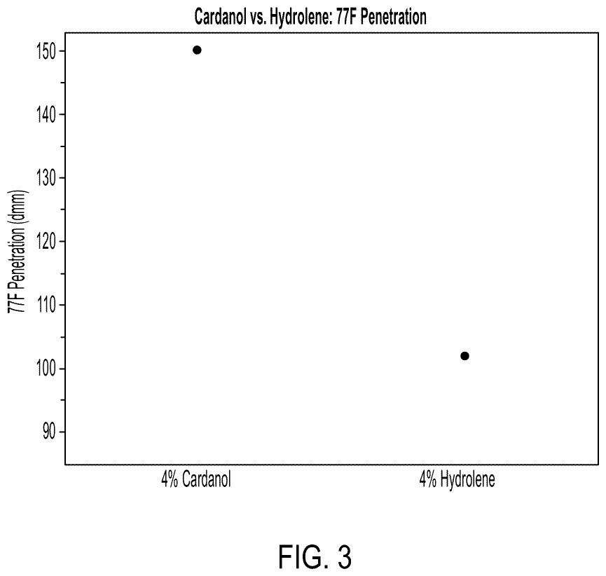

The penetration value of each sample was assessed under the standards of ASTM D5M-20 (“Standard Test Method for Penetration of Bituminous Materials”) and is provided in FIG. 3.

As shown in FIG. 3, the asphalt adhesive composition comprising Compatibilizer A exhibited an improved penetration value at 77° F. as compared to the otherwise identical asphalt composition comprising Compatibilizer C.

### Example 3(d): Effect of Compatibilizer Type on SAU Sticky Batch Bond Strength at 40° F.

A study was conducted to evaluate the impact of the type of compatibilizer on the adhesion performance at low temperatures (40° F.) of asphalt adhesive (“sticky batch”) formulations for use in self-adhered roofing underlayment (SAU) products. Specifically, the purpose of this study was to evaluate the low temperature performance of the particular phenolic lipid-based compatibilizer constituting a liquid distillate extracted from a cashew nut shell liquid, i.e., Cardanol (“Compatibilizer A”), as compared to hydrolene, a conventional petroleum-based compatibilizer oil used in asphalt adhesive (“sticky batch”) formulations (i.e., “Compatibilizer C”).

An asphalt adhesive composition comprising Cardanol (Compatibilizer A) was prepared for the purposes of comparison to an asphalt adhesive composition comprising conventional Compatibilizer C (hydrolene). Both of the asphalt adhesive compositions included an identical base asphalt comprising 100% roofing flux, together with identical polymer additives and asphalt fillers. The asphalt adhesive compositions comprised the respective compatibilizers in an amount of 4 wt. %, based upon the total weight of the asphalt adhesive composition on an unfilled basis.

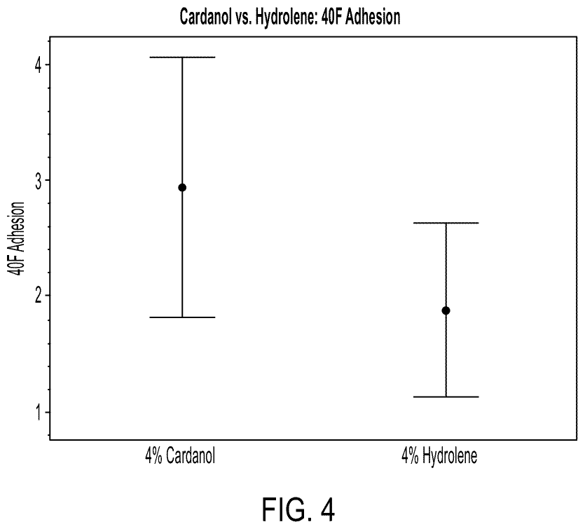

The bond strength of each respective asphalt adhesive was assessed at 40° F. under the standards of ASTM D1970-21 (“Standard Specification for Self-Adhering Polymer Modified Bituminous Sheet Materials Used as Steep Roofing Underlayment for Ice Dam Protection”), specifically with respect to Section 7.4 (“Adhesion to Plywood”), and is provided in FIG. 4.

As shown in FIG. 4, the asphalt adhesive compositions comprising Compatibilizer A exhibited an improved (i.e., higher bond strength) cold weather adhesion performance as compared to the otherwise identical asphalt adhesive compositions comprising Compatibilizer C.

### Example 3(e): Effect of Compatibilizer Type on SAU Sticky Batch Bond Strength at 75° F.

A study was conducted to evaluate the impact of the type of compatibilizer on the adhesion performance at moderate temperatures (75° F.) of asphalt adhesive (“sticky batch”) formulations for use in self-adhered roofing underlayment (SAU) products. As in Example 3(d), the purpose of this study was to evaluate the performance of the particular phenolic lipid-based compatibilizer constituting a liquid distillate extracted from a cashew nut shell liquid, i.e., Cardanol (“Compatibilizer A”), as compared to hydrolene, a conventional petroleum-based compatibilizer oil used in asphalt adhesive (“sticky batch”) formulations (i.e., “Compatibilizer C”).

Three asphalt adhesive compositions comprising Cardanol (Compatibilizer A) were prepared for the purposes of comparison to three otherwise identical asphalt adhesive compositions comprising conventional Compatibilizer C (hydrolene). Each of the asphalt adhesive compositions included an identical base asphalt comprising 100% paving grade asphalt, together with identical polymer additives and asphalt fillers. The asphalt adhesive compositions comprised the differing compatibilizers in amounts of 2 wt. %, 3 wt. %, and 4 wt. %, respectively, based upon the total weight of the asphalt adhesive composition on an unfilled basis.

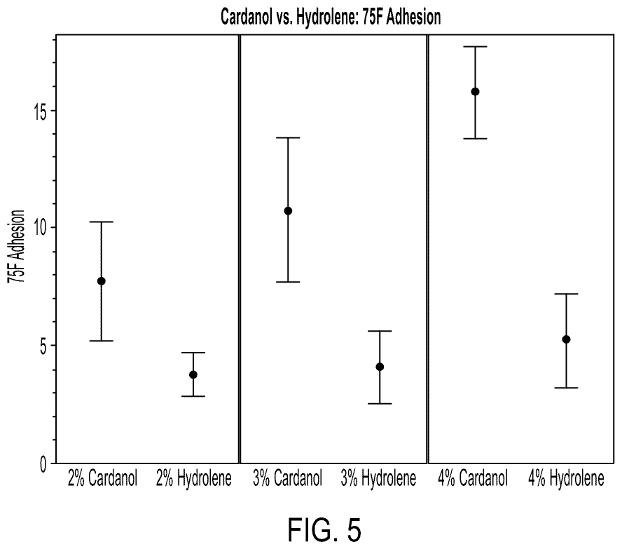

The bond strength of each respective asphalt adhesive was assessed at 75° F. under the standards of ASTM D1970-21 (“Standard Specification for Self-Adhering Polymer Modified Bituminous Sheet Materials Used as Steep Roofing Underlayment for Ice Dam Protection”), specifically with respect to Section 7.4 (“Adhesion to Plywood”), and is provided in FIG. 5.

As shown in FIG. 5, the asphalt adhesive compositions comprising Compatibilizer A exhibited an improved (i.e., higher bond strength) cold weather adhesion performance as compared to the otherwise identical asphalt adhesive compositions comprising Compatibilizer C. This result was observed at each of the 2 wt. %, 3 wt. %, and 5 wt. % compatibilizer loadings, respectively.

### Example 4

A study was conducted to evaluate the impact of the subject compatibilizer on the adhesion performance of asphaltic-based shingle sealant products at low temperatures (40° F.).

In this study, two asphaltic-based sealant compositions comprising a phenolic lipid-based compatibilizer constituting a liquid distillate extracted from a cashew nut shell liquid, i.e., Cardanol (“Compatibilizer A”) were prepared, for the purposes of comparison against an otherwise identical sealant composition not including a compatibilizer. All of the compositions included an identical modified asphalt material. The two exemplary sealants (Sample 3A and Sample 5A) comprised the compatibilizer Cardanol in amounts of 3 wt. % or 5 wt. %, respectively, based upon the total weight of the modified asphalt material. The comparative sealant (Control) was otherwise identical, but did not include any compatibilizer.

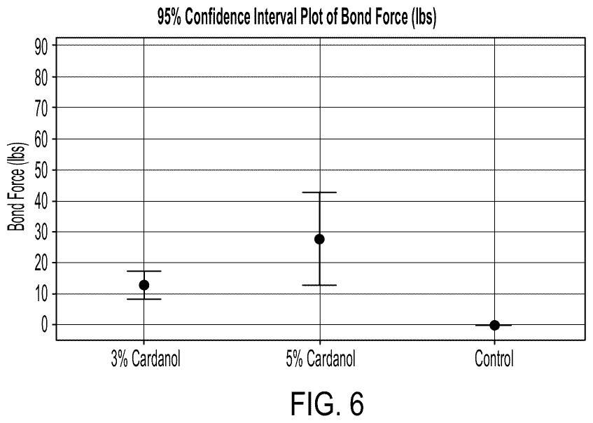

The bond strength of each respective sealant was assessed at 40° F. under the standards of modified ASTM D6381 (“Standard Test Method for Measurement of Asphalt Shingle Mechanical Uplift Resistance”) and is provided in FIG. 6. As detailed above, the sealant bond force was measured with a modification to a higher 12 in/min testing speed, as opposed to the ASTM D6381 standard 5 in/min testing speed. In accordance with ASTM D6381, the conditioning time was 48 hours, the conditioning temperature was 40° F., and the test temperature was 40° F.

As shown in FIG. 6, the sealant compositions comprising Compatibilizer A exhibited an improved (i.e., higher bond strength) cold weather adhesion performance as compared to the otherwise identical sealant composition devoid of the compatibilizer. To be clear, the control composition effectively failed to provide cold weather adhesion performance to the sealant. In contrast, the sealants comprising Compatibilizer A exhibited an average bond strength at 40° F. of 12.5 lbs. of force (Sample 3A) and 27.7 lbs. of force (Sample 5A), respectively.

What is claimed is:

1. An asphalt composition comprising:
a modified asphalt material, the modified asphalt material comprising:
from 10 to 99 wt. % of a base asphalt, based upon the total weight of the modified asphalt material; and
from 1 to 20 wt. % of a phenolic lipid-based compatibilizer, based upon the total weight of the modified asphalt material,
wherein the asphalt composition exhibits an improved adhesion at temperatures of 40° F. or lower as compared to an otherwise identical asphalt composition devoid of the phenolic lipid-based compatibilizer.

2. The asphalt composition of claim 1, wherein the asphalt composition comprises:
the modified asphalt material; and
a filler material.

3. The asphalt composition of claim 1, wherein the modified asphalt material comprises from 1.5 to 10 wt. % of the phenolic lipid-based compatibilizer, based upon the total weight of the modified asphalt material.

4. The asphalt composition of claim 1, wherein the asphalt composition has a bond strength at 40° F. of 5 to 50 lbs. of force, as measured in accordance with modified ASTM D6381.

5. The asphalt composition of claim 1, wherein the asphalt composition exhibits an improved penetration value at 77° F. as compared to an otherwise identical asphalt composition devoid of the phenolic lipid-based compatibilizer.

6. The asphalt composition of claim 1, wherein the asphalt composition has a penetration value at 77° F. of 70 dmm or greater, as measured in accordance with ASTM D5.

7. The asphalt composition of claim 1, wherein the asphalt composition exhibits an improved viscosity at temperatures of 300° F. or higher, as compared to an otherwise identical asphalt composition devoid of the phenolic lipid-based compatibilizer.

8. The asphalt composition of claim 1, wherein the base asphalt comprises paving grade asphalt, oxidized asphalt, non-oxidized asphalt, or mixtures thereof.

9. The asphalt composition of claim 1, wherein the modified asphalt material is a polymer-modified asphalt material comprising an amount up to 20 wt. % of a polymer additive, based upon the total weight of the modified asphalt material.

10. The asphalt composition of claim 9, wherein the polymer additive comprises one or more of reclaimed rubber, natural rubber, ground tire rubber, depolymerized ground tire rubber, styrene-butadiene block copolymer (SBS), chloroprene rubber (CR), amorphous polyolefin, latex, butadiene rubber (BR), acrylonitrile-butadiene rubber (NBR), isoprene rubber (IR), styrene-isoprene, styrene-polyisoprene-styrene (SIS), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated styrenic block copolymers, vinylacetate/polyethylene (EVA), or mixtures thereof.

11. The asphalt composition of claim 9, wherein the polymer-modified asphalt composition comprises a weight percent ratio of phenolic lipid-based compatibilizer to polymer additive [compatibilizer:additive] of from 1:5 to 1:1.

12. The asphalt composition of claim 1, wherein the phenolic lipid-based compatibilizer is devoid of carboxyl groups, carbonyl groups, or combinations thereof.

13. The asphalt composition of claim 1, wherein the phenolic lipid-based compatibilizer is devoid of sterols, stanols, or combinations thereof.

14. The asphalt composition of claim 1, wherein the phenolic lipid-based compatibilizer is extracted from a bio-based source material.

15. The asphalt composition of claim 14, wherein the phenolic lipid-based compatibilizer comprises a liquid distillate extracted from a bio-based source material.

16. The asphalt composition of claim 1, wherein the phenolic lipid-based compatibilizer has a molecular weight of less than 1,800 g/mol.

17. The asphalt composition of claim 16, wherein the phenolic lipid-based compatibilizer has a molecular weight of from 300 to 900 g/mol.

18. The asphalt composition of claim 1, wherein the phenolic lipid-based compatibilizer is a non-polymerized compatibilizer.

19. The asphalt composition of claim 1, wherein the compatibilizer comprises cashew nut shell distillate, Cardol, Cardanol, derivatives thereof, or mixtures thereof.

20. The asphalt composition of claim 1, wherein the asphalt composition is devoid of recycled asphalt material.
